(19) United States
(12) Patent Application Publication
(10) Pub. No.: US 2008/0289171 A1
(43) Pub. Date: Nov. 27, 2008

(54) METHOD FOR ASSEMBLING A STACKED PLATE ELECTROCHEMICAL DEVICE

(76) Inventor: Jason Cheng, New Westminster (CA)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/751,765

(22) Filed: May 22, 2007

(51) Int. Cl. H01M 6/00

(52) U.S. Cl. 29/623.1

(57) ABSTRACT

The present invention relates to an improved method for assembling a stacked plate electrochemical device. According to an exemplary embodiment of the invention, two pairs of electrodes are provided: two cathodes and two anodes. Each electrode in each pair is connected to the other electrode via conductive interconnects. The pairs of electrodes are then folded together forming an electrode package, such that the cathodes and anodes alternate position within the electrode package. A number of electrode packages are then stacked together depending on the desired number of electrodes in the stacked plate cell. The stacked electrodes are then placed in a cell can and the conductive interconnects are connected to the cell can terminals to form the stacked plate electrochemical device. Processes according to exemplary embodiments of the present invention result in a faster, more efficient assembly time for the stacked plate electrochemical device.

### FIELD OF INVENTION

The present invention relates to a method of assembling an electrochemical device, and more particularly to a method of assembling electrodes into an electrode stack for use in a stacked plate cell electrochemical device.

### BACKGROUND OF THE INVENTION

The number of available portable electronic devices, including portable medical devices, continues to proliferate. This proliferation is accompanied by a heightened effort to make the portable devices a small as feasible. As portable electronic devices continue to decrease in size, the size of the batteries which power those devices begins to impose a minimum size of the devices. Additionally, the cost of the batteries can greatly influence the cost of the devices. For these and other reasons, thin prismatic batteries, such as lithium ion prismatic batteries, have become widely used to power portable electronic devices. Additionally, prismatic batteries are available in a wide range of shapes because of the way the cathodes and anodes are deployed within the batteries.

A conventional method of assembling an electrode stacked plate cell is to stack individual electrodes together, starting with an anode on the bottom and then alternating cathodes and anodes in the stack until a desired number of cathodes is reached. Then a final anode is placed on top to allow both sides of the final cathode to be active, thereby fully utilizing all the cathodes in the stack. According to this process, for a stacked plate cell with 27 electrodes, thirteen cathodes and thirteen anodes, thirteen pairs of electrodes and the final top anode must be stacked individually. This stacking process is time consuming and adds significantly to the cost of producing the stacked plate cell.

At some point, before, during, and/or after the stacking process, interconnects need to be formed between the individual electrodes. One known method for forming these interconnects is to attach a metal tab to each anode and each cathode. Such currently-known methods have certain inefficiencies. For example, a tab needs to be welded or otherwise attached to each individual cathode and anode to allow the interconnects to be formed: where there are 27 electrodes, 27 metal tabs need to be attached. Other currently-known methods require the interconnects to be attached to the electrodes during electrode formation. For example, a piece of conductive foil may be embedded in the electrode while the electrode is being formed. Where there are 27 electrodes, 27 embedding steps would be required to embed the interconnects in the electrodes in this manner.

After the tabs are attached, and after the electrodes are stacked, the anode tabs are connected to the anode cell terminal. Similarly, the cathode tabs are connected to the cathode cell terminal. This and other currently-known assembly and attaching processes are inefficient and significantly increase the cost of the stacked plate cell.

### SUMMARY OF THE INVENTION

While the ways in which the present invention addresses the disadvantages of the prior art will be discussed in greater detail below, a general summary is provided here. The present invention relates to an improved method for assembling a stacked plate cell that results in a faster, more efficient, assembly time while maintaining the quality of the stacked plate cell produced by current methods. Stacked plate cells for use in electrochemical devices produced according to the present invention have numerous applications, for example, in stacked plate cell batteries, fuel cells, medical devices, micro devices, and/or any device and/or application that requires electrochemical energy.

According to an exemplary embodiment of the disclosed process, the increased efficiency is achieved by folding two pairs of electrodes (two anodes and two cathodes) together at the same time, instead of assembling a single pair at a time as discussed above. Folding two pairs at the same time reduces the time to assemble the entire stacked plate cell. For example, where 29 electrodes are needed (15 anodes and 14 cathodes), only seven sets of four folded electrodes need to be stacked along with the single anode that is stacked on top—eight total stacking steps. In comparison, according to currently-known processes, a cell having 29 electrodes would require fourteen pairs of electrodes to be stacked along with the single anode stacked on top—fifteen total stacking steps. Thus, the presently disclosed method reduces assembly time and cost of production.

In a further embodiment, as will be discussed in more detail below, the metal tabs that serve as interconnects between the electrodes are simultaneously embedded in two electrodes at the same time the electrodes are formed. For example, in an exemplary embodiment, an electrode slurry is used to coat a piece of conductive foil. The slurry/foil combination is cured to form two areas of electrode material in electrical communication with the foil. The foil is then cut to produce a pair of electrodes connected by the metal foil interconnect, eliminating the step of individually embedding an already-formed interconnect in each electrode.

In accordance with an exemplary embodiment of the invention, a method of assembling a stacked plate cell comprises the steps of (i) providing a plurality of cathode plates, each comprising a plurality of cathode electrodes; (ii) providing a plurality of anode plates, each comprising a plurality of anode electrodes; (iii) providing a plurality of separators; (vi) providing a cell can which comprises a cathode terminal and an anode terminal; (v) folding the cathode and anode plates together; (vi) inserting the plurality of separators between the individual cathode and anode electrodes; and (4) connecting the cathode electrodes and anode electrodes respectively to the cathode terminal and the anode terminal.

In a further embodiment of the invention, each of the electrodes on a single electrode plate is symmetrical to the other about a folding axis, and in one embodiment the electrodes are substantially D-shaped and are mirror images of each other. The folding axis generally (i) bisects the current collector which serves as an interconnect between the two electrodes on the electrode plate and (ii) is the axis about which the individual electrodes are mirrored.

### BRIEF DESCRIPTION OF THE DRAWING FIGS.

FIG. 1 is a plan view of a single electrode plate in accordance with an exemplary embodiment of the invention.

FIG. 2 is a plan view of a cathode electrode plate and an anode electrode plate in accordance with another embodiment of the invention.

FIG. 3 is a perspective view of a cathode electrode plate and an anode electrode plate, according to one embodiment of the invention, in preparation for the method disclosed herein.

FIG. 4 is a perspective view of a set of two individual cathode electrodes and a set of two individual anode electrodes, including the current collectors attached to each electrode, according to one embodiment of the invention.

FIG. 5 is an exploded-perspective view of an assembled battery according to an exemplary embodiment of the invention.

FIG. 6 is a sectional view of an assembled battery according to one embodiment of the invention, showing the spacing of the cathodes and anodes, and showing the anode current collectors attached to a battery terminal.

FIG. 7 is a plan view of the outside of an assembled battery showing the exposed battery terminals according to an embodiment of the invention.

FIG. 8 is a sectional view, similar to FIG. 6, of an assembled battery according to one embodiment of the present invention, showing the spacing of the cathodes and anodes, and showing the cathode current collectors attached to a battery terminal.

FIG. 9 is a flowchart representing a preferred embodiment of the method herein disclosed.

FIG. 10 is a side view of the cell stack, according to an exemplary embodiment of the invention, showing the cathode and anode electrodes folded together and stacked and the single anode on top of the stack, as well as the separators between the individual electrodes, and the current collectors attached to the electrodes.

FIG. 11 is a plan view of one electrode plate, showing the insertion of the electrode plate into the separator bag(s), according to one embodiment of the invention.

FIG. 12 is a side sectional view of the electrode stack, showing the placement of the cathodes, anodes, and separators, according to one embodiment of the invention.

FIG. 13 is a flowchart representing another preferred embodiment of the method disclosed, according to one embodiment of the invention.

FIG. 14a is a perspective view of the cathode and anode connector tabs according to one embodiment of the invention.

FIG. 14b is a perspective view of the electrode connector tabs proximate a tab header according to a further embodiment of the invention.

FIG. 14c is a perspective view of the electrode connector tabs proximate a tab header and formed to receive the cathode and anode current collectors in another embodiment of the invention.

FIG. 15a is a side view, according to one embodiment of the present invention, of a welding apparatus configured to connect the electrode current collectors and the electrode connector tabs.

FIG. 15b is an exploded perspective view of the positioning of a cell stack, tab header, electrode connector tabs, and a welding apparatus in preparation for connecting the electrode current collectors to the electrode connector tabs and the tab header.

FIG. 16a is a perspective view of an electrode stack according to an embodiment of the present invention.

FIG. 16b is a perspective view of an electrode stack according to an embodiment of the present invention.

FIG. 16c is a perspective view of an electrode stack according to an embodiment of the present invention.

FIG. 16d is a perspective view of an electrode stack according to an embodiment of the present invention.

### DETAILED DESCRIPTION

The following description is of exemplary embodiments of the invention only, and is not intended to limit the scope or applicability of the invention in any way. Rather, the following description is intended to provide convenient illustrations for implementing various embodiments of the invention. As will become apparent, various changes may be made to the methods described in these embodiments without departing from the spirit and scope of the invention.

In accordance with various embodiments of the present invention, a method of assembling electrodes into a stacked plate cell is disclosed. Such a stacked plate cell may, for example, be used in a stacked plate electrochemical device. In various embodiments, the stacked plate cell may be used in a stacked plate cell battery. In a stacked plate cell, electrodes, such as cathodes and anodes, alternate position so that a cathode is not directly adjacent to another cathode, and an anode is not directly adjacent to another anode. The function of cathodes and anodes is well known in the field of stacked plate cell and other batteries. The method of assembling the electrodes into the stacked plate cell influences the speed and efficiency at which the stacked plate cell is assembled. Various embodiments of the present invention provide for a faster, more efficient assembly of the stacked plate cell.

Initially, according to one embodiment of the invention, the shape of the cavity which houses the stacked plate electrochemical device is determined. One advantage of the presently disclosed method for producing a stacked plate electrochemical device is that the method may be used to produce stacked plate cell batteries in any number of different shapes and sizes. For example, according to one embodiment of the invention, the stacked plate electrochemical device is substantially D-shaped. Other embodiments provide that the shape of the device may be any shape required by a particular application, for example a shape required for a medical device, a cellular telephone, a digital camera, and other electronic devices. Regardless of the shape of a particular stacked plate electrochemical device, the present invention provides for faster, more efficient assembly of the stacked plate cell.

In various embodiments of the present invention, myriad shapes are available for the stacked plate electrochemical device depending on the application for which the device is used. For example, any shape that is capable of being mirrored across a folding axis, folding axis 11, for example, may be employed. Once mirrored, the profile of each electrode on an electrode plate is symmetric to the other electrode on the electrode plate about folding axis 11, such that when the electrodes are folded together, they substantially overlap each other and are configured to fit within a cell can, casing, or housing that receives the stacked electrodes. In other embodiments, the profile of each electrode need not be symmetrical, but is configured to fit within a cell can of any shape.

In general, according to an exemplary embodiment of the present invention, after a shape for the electrochemical device is determined, the desired number of electrodes is calculated. Next, a sufficient number of electrode plates are produced according to various embodiments of the invention, some of which are discussed below. After the electrode plates are produced, one pair of cathodes is formed together with one pair of anodes, forming an electrode package. The process of forming electrode packages is repeated with the remaining electrode plates. Then the electrode packages are stacked together and the assembly of electrode packages is placed within a cell can that is configured to house the electrodes, such that the cell can provides rigidity, support and protection for the stacked plate cell. The cell can may also comprise cathode and anode terminals to which the cathode and anode electrodes are electrically connected.

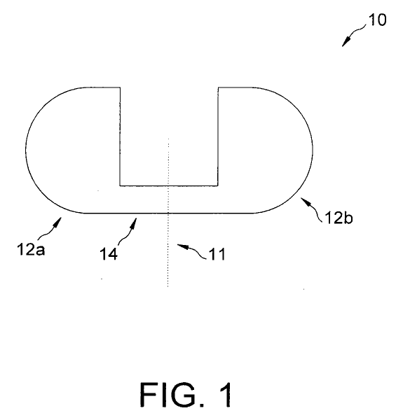

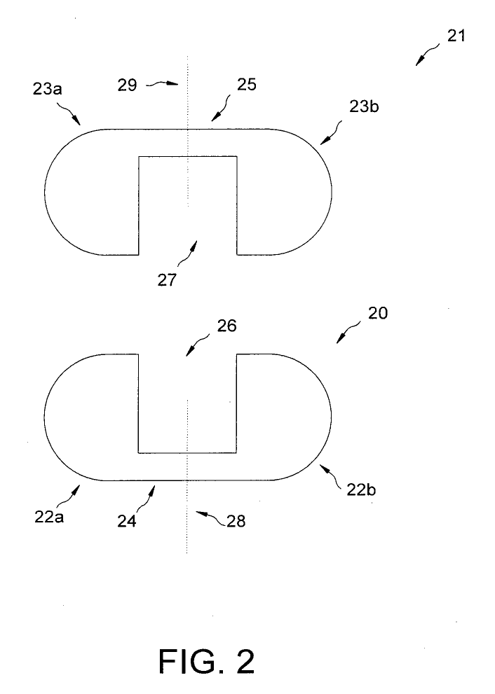

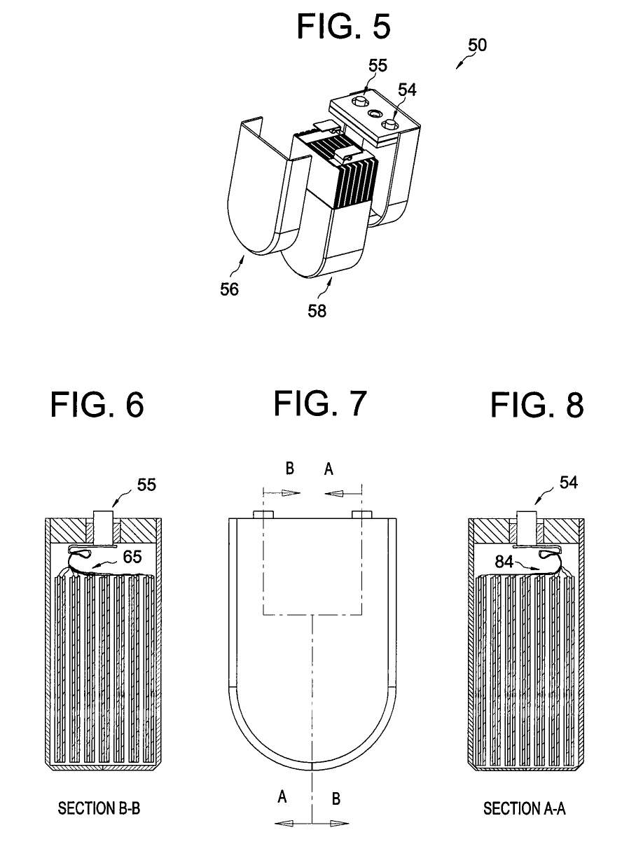

According to an exemplary embodiment of the invention, FIGS. 1 and 2 show the dual-electrode plates 10, 20, 21 that are produced and used in conjunction with a substantially D-shaped cell can 56 (see FIG. 5, for example). A dual-electrode plate 10 comprises two electrodes 12a-b and an electrode current collector 14. The electrode current collector 14 is physically and conductively connected to the two electrodes 12a-b, such that the current collector 14 receives the current from and electrically communicates with the electrodes 12a-b. In one embodiment of the invention, the electrodes 12a-b are substantially D-shaped such that they may be used in conjunction with a substantially D-shaped cell can 56. In other embodiments of the invention, the electrodes 12a-b are designed to fit in a particular cell can. For example, the electrodes may be substantially rectangular, square, oval, circular, elongated, or any other shape capable of being mirrored about an axis, folding axis 11 for example.

In one embodiment of the invention, folding axis 11 is horizontally oriented. For example, where each electrode 12 is vertically oriented with respect to the other electrode, folding axis 11 is horizontal. In another embodiment where each electrode 12 is horizontally oriented with respect to the other electrode, as in FIG. 1, folding axis 11 is vertical. In yet other embodiments, folding axis 11 is oriented to allow the electrodes to appropriately fold together.

In a further embodiment of the invention, two different types of dual-electrode plates 10 are produced: cathode dual-electrode plates 20 and anode dual-electrode plates 21. The anode dual-electrode plate 21 may be formed from a single piece of anode material or from multiple pieces of anode material. Different types of anode material are well known in the art, and in exemplary embodiments of the invention, the anode material may comprise tin oxide (SnO₂), amorphous silicon, lithium titanate (Li₄Ti₅O₁₂), lithium (Li) metal, carbon based materials and or alkaline metals, such as sodium and potassium. In further embodiments of the invention, the anode material may comprise any material now known or developed in the future that functions as an anode and/or a negative electrode. The anode plate 21 produced according to various embodiments of the present invention comprises two similarly-sized individual anode electrode elements 23a-b connected by an anode current collector 25. In one embodiment of the present invention, the anode current collector 25 is a substantially rectangular element that connects, physically and conductively, the individual anode electrodes 23a-b. The anode current collector 25 serves as an electrical conductor that provides an electrical connection to the individual anode electrodes 23a-b, and that allows the anodes 23a-b to electrically communicate with the anode cell terminal 55.

According to another embodiment of the invention, the cathode dual-electrode plate 20 may be formed from a single piece of cathode material or from multiple pieces of cathode material. Different types of cathode material are well known in the art, for example, SO₂, MnO₂, CFₓ, V₂O₅, LiCoO₂, Li₂Mn₂O₄, Ag₂V₄O₁₁, LiNi_{0.33}Co_{0.33}Mn_{0.33}O₂, LiNiO₂, LiFePO₄, Li₂Ni_{0.5}Mn_{1.5}O₄, LiNiₓCoₓO₂, LiNi_{0.82}Co_{0.18}O₂, LiNi_{0.8}Co_{0.2}O₂, and/or LiNi_{0.8}Co_{0.15}Al_{0.05}O₂. Other materials may be used to produce the cathodes without departing from the scope of the present invention, for example, the elements in the above formulations may be combined in other combinations, ratios, and/or percentages. The cathode plate 20 produced according to various embodiments of the present invention comprises two similarly-sized individual cathode electrode elements 22a-b connected by a cathode current collector 24. In one embodiment of the present invention, the cathode current collector 24 is a substantially rectangular element that connects, physically and conductively, the individual cathode electrodes 22a-b. The cathode current collector 24 serves as an electrical conductor that provides an electrical connection to the individual cathode electrodes 22a-b, and that allows the cathodes 22a-b to electrically communicate with the cathode cell terminal 54. In one embodiment of the present invention, the individual cathode electrodes 22a-b are similar in size to the anode electrodes 23a-b; in other embodiments, the individual cathode electrodes 22a-b are smaller or larger than the anode electrodes 23a-b.

In an exemplary embodiment of the present invention, current collector 14 is embedded in two electrodes simultaneously. For example, current collector 14 may be formed from a conductive metal, such as a conductive foil. Dual-electrode plate 10 may be formed according to the following process. An appropriately-sized piece of conductive foil is provided. Then a pliable, moldable, and/or formable electrode slurry is produced which comprises an electrode powder and an electrode bonding agent. The electrode slurry is then positioned on the conductive foil according to a desired position for the electrodes. For example, where dual-electrode plate 10 is being produced, a piece of conductive foil is provided that is at least as large as dual-electrode plate 10. Two portions of the electrode slurry would be placed on the conductive foil according to the relative position of electrodes 12a, 12b on dual-electrode plate 10. After the electrode slurry is positioned, the foil/slurry assembly is cured such that the electrode bonding agent evaporates and electrodes 12a, 12b are formed. After the electrodes are formed, the conductive foil is cut to substantially produce the profile of dual-electrode plate 10, such that current collector 14 physically and conductively connects electrodes 12a, 12b. In exemplary embodiments, the foil may be cut by punching and/or laser cutting; however, and method for cutting the foil is within the scope of the present invention. In other embodiments of the invention, pre-shaped current collectors 14 may be embedded individually within electrodes 12a, 12b in order to form dual-electrode plate 10. Other methods of producing dual-electrode plate 10 are also contemplated within the scope of the present invention.

Although the current collector 14 may be substantially rectangular, many other shapes are possible in other embodiments of the invention. Current collector 14 is designed to be able to fold at some axis or some point along the current collector. The folding facilitates the overlapping of the two electrodes 12a-b on the dual-electrode plate 10. When folded, current collector 14 is also capable of being connected to a stacked plate cell terminal, for example, a cathode cell terminal 54 and/or an anode cell terminal 55.

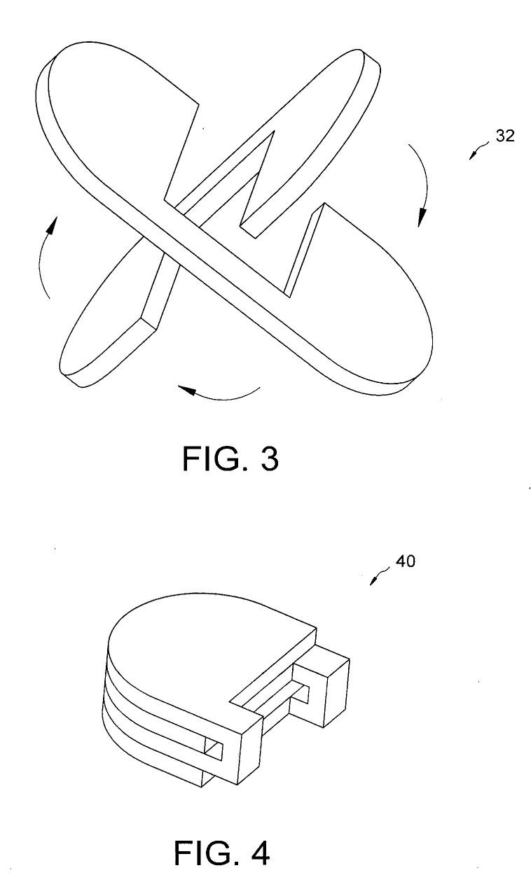

In one embodiment of the invention, the current collectors 14, 24, 25 are located on one side of the anode plate 21 and on an opposite side of the cathode plate 20. Other embodiments allow for the anode current collectors 25 to remain separate from the cathode current collectors 24 when the plates are folded and stacked together, preventing the anode current collectors 25 from physically contacting the cathode current collectors 24 (see FIGS. 3 and 4).

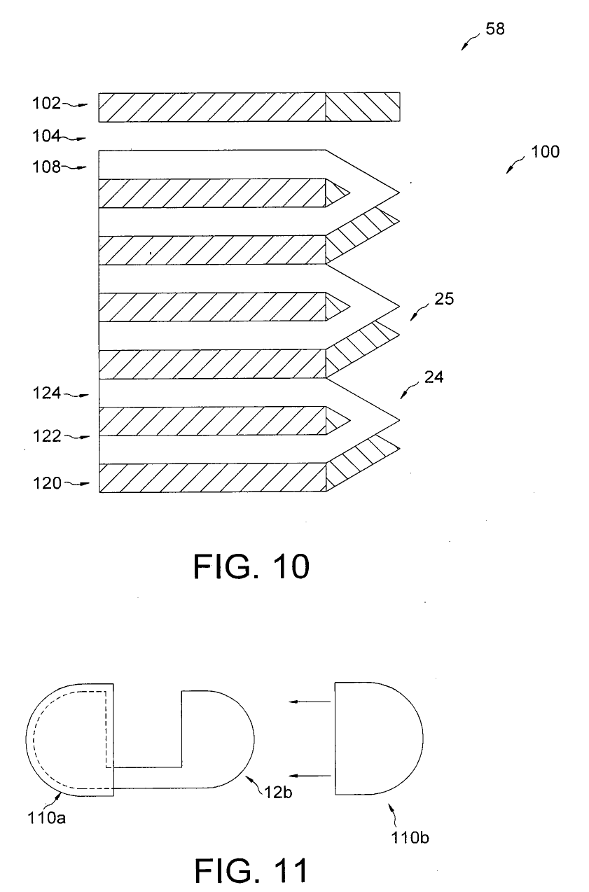

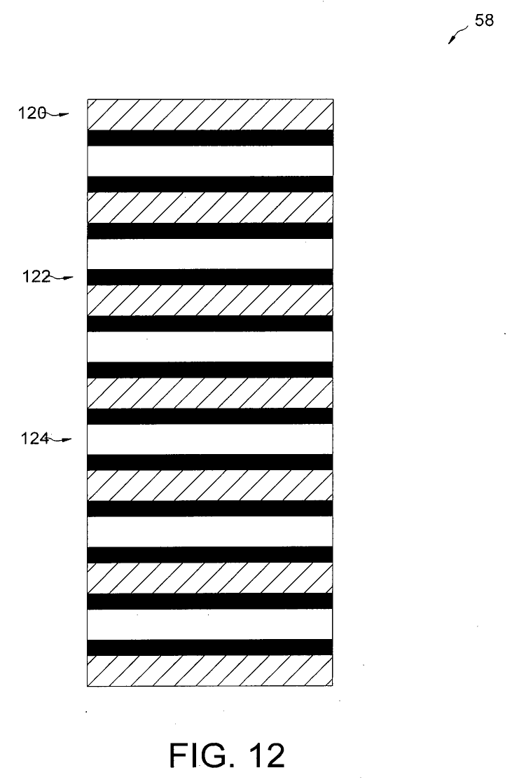

In an exemplary embodiment of the invention, a separator 122 is located between each cathode and each anode electrode in the cell stack. For example, FIGS. 10 and 12 show the location of the anode electrodes 120, the cathode electrodes, 124, and the separators 122. In one embodiment of the invention, the separator material is a polymer mesh, where an electrolyte resides in the voids of the separator material. The separators 122 may comprise a polymer, and in various embodiments, the separators comprise polypropylene, polyethylene, and/or a combination of polypropylene, polyethylene, and/or other polymers. In exemplary embodiments, the electrolyte comprises solid lithium salts such as LiPF₆, lithium bisoxalateborate (LiBOB), LiBF₄, LiAsF₆, LiSbF₆, Li₂(B₁₂FₓH₁₂₋ₓ), LiSO₃CF₃, LiN(SO₂CF₃)₂, LiN(SO₂C₂F₅)₂, and/or LiClO₄ and organic solvents. In further embodiments, the organic solvents may comprise propylene carbonate (PC), dimethoxyethane (DME), dimethylcarbonate (DMC), ethyl methyl carbonate (EMC), ethylene carbonate (EC), gamma-butyrolactone, tetrahydrofuran, methyl acetate, diglyme, triglyme, tetraglyme, diethyl carbonate (DEC), acetonitrile, dimethyl sulfooxide, dimethyl formamide, dimethyl acetmide, other organic carbonates and/or combinations or mixtures thereof.

In some embodiments, each cathode 22a-b or anode 23a-b is inserted into a separator bag 110a-b (see FIG. 11). In a further embodiment of the present invention, each cathode plate 20 or anode plate 21 is inserted into a single separator bag for the entire plate. In still another embodiment of the invention, the separators 122 are placed between the cathodes 124 and anodes 120 after the folding process, discussed below, has occurred. According to yet another embodiment, the cathodes 22a-b are smaller than the anodes 23a-b so that there is room for the separator bags 110a-b within the cell can 56, and such that the separator bags 110a-b do not adversely effect the structure, size, rigidity, durability, etc. of the cell stack 58. In still other embodiments, the cathode may be larger than the anode, for example, in lithium primary cells. The separator bags 110a-b provide electrical insulation between the cathodes 22a-b and anodes 23a-b when the cathode and anode plates 20, 21 are assembled into the cell stack 58, such that current flows through the current collectors and not directly from electrode plate to electrode plate. Further, the separator bags 110a-b allow for electrical current to flow appropriately between the cathodes 22a-b and anodes 23a-b.

According to a preferred embodiment of the present invention, following insertion of the cathode dual-electrode plates 20 and/or anode dual-electrode plates 21 into separator bags 110a-b, a cathode dual-electrode plate 20 is folded together with an anode dual-electrode plate 21, forming an electrode package 40 (see FIGS. 3 and 4, for example). The folding process now described is repeated until the desired number of electrode packages is produced. First, a cathode plate 20 is positioned in a generally-intersecting, and/or perpendicular fashion to an anode plate 21, such that one geometric plane wherein the cathode current collector 24 lies is substantially parallel to one geometric plane wherein the anode current collector 25 lies. In other embodiments, the anode current collector 25 is positioned within the cathode plate opening 26, and the cathode current collector 24 is positioned within the anode plate opening 27. In yet another embodiment, the current collectors 24, 25 are generally not in parallel geometric planes, and the cathode current collectors 24 and the anode current collectors 25 are not in physical contact with each other after the dual-electrode plates 20, 21 have been folded. FIG. 3 shows, according to a preferred embodiment, how the individual electrodes are folded in the same direction (for example, the direction may be clockwise 32) in order to form an electrode package 40. Within electrode package 40, the cathodes 22a-b and anodes 23a-b alternate position, such that no cathode is directly adjacent to another cathode, and no anode is directly adjacent to another anode.

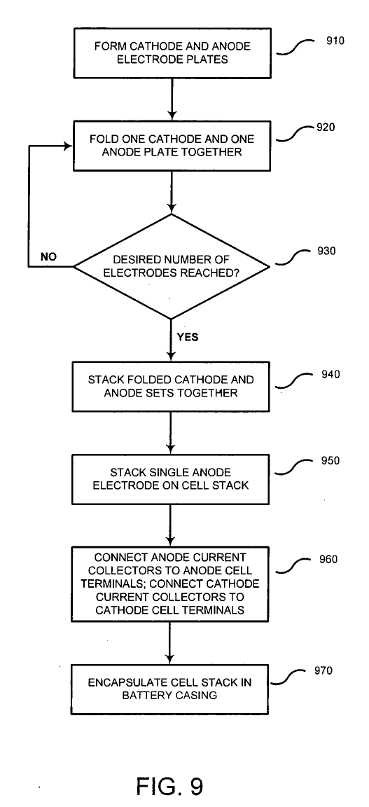

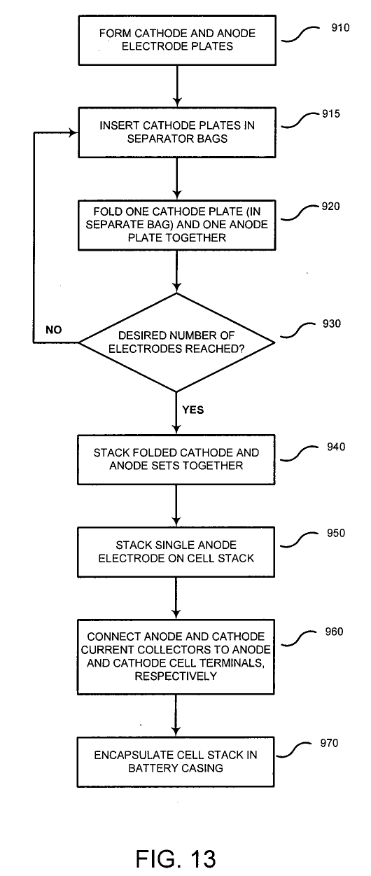

In one embodiment of the present invention, after an electrode package 40 is produced, it is set aside until a sufficient number of electrode packages have been produced to yield the total number of desired electrodes in the electrode packages. In another embodiment of the invention, the total number of desired electrodes in the electrode packages is 12; in yet another embodiment, the desired number of electrodes is 16; in a further embodiment, the desired number is 28. In exemplary embodiments, the range of electrodes for the cell stack is 12 to 52 electrodes. FIGS. 9 and 13 show the process herein disclosed. Control point 930 requires certain previous steps to be repeated until the desired number of electrodes is produced. In one embodiment of the present invention, the steps of inserting electrode plates 10 into separator bags 110a-b (step 915) and folding a cathode plate 20 and an anode plate 21 together (step 920) are repeated. In another embodiment of the invention, where separators 122 are inserted later, only step 920 is repeated. According to further embodiments of the invention, steps other than those depicted in FIGS. 9 and 13 may be utilized in assembling the stacked plate cell. For example, in an exemplary embodiment, the additional step of inserting a separator between the cathodes and anodes is employed in accordance with the process depicted in FIG. 9. In accordance with various embodiments, the separator may be inserted between the cathodes and anodes at any point in the process where it is possible to insert the separator between the cathodes and anodes.

According to an exemplary embodiment, after a sufficient number of electrode packages 40 have been produced, the electrode packages 40 are stacked together forming a cell stack 58. The electrode packages 40 are stacked such that cathodes 22 and anodes 23 continue to alternate throughout the stack. In one embodiment, a stacked plate cell having twelve individual electrodes 12 only requires stacking three times, because only three electrode packages 40 are stacked together. Previous applications, on the other hand, required stacking six times to produce a cell stack with twelve individual electrodes, because each cathode/anode pair had to be individually stacked. Thus, the present disclosure provides for faster, more efficient assembly time of the cell stack 58.

FIG. 10 shows a configuration of the cell stack 58 according to a preferred embodiment of the present disclosure. In such an embodiment, it is desirable to have a single anode electrode 102 on the top 104 and bottom 106 of the cell stack 58, thereby utilizing all cathode surfaces in the stacked plate cell. Therefore, in this embodiment, after the electrode packages 40 are stacked together, a single anode electrode 102 is placed on top of the topmost cathode 108 of the cell stack 58. According another embodiment, the cell stack 58 comprises an odd number of anode electrodes 23, and an even number of cathode electrodes 24. In a further embodiment, the cell stack 58 comprises an odd number of cathode electrodes 22 and an even number of anode electrodes 23. According to an exemplary embodiment, with the additional anode stacked on top of the cell stack, the total number of electrodes may be 13; in another embodiment, the total number of electrodes may be 29; in still another embodiment of the invention, the total number of electrodes may be 53. A further exemplary embodiment provides a stacked plate cell that does not comprise an additional anode, such that an equal number of cathodes and anodes are present in the cell stack, and such that the step of stacking an additional anode need not be carried out.

FIGS. 5-8 show an assembled stacked plate cell electrochemical device 50 according to a preferred embodiment of the present invention. After cell stack 58 has been assembled, electrical connections are made between the anode current collectors 25, 65, such that the anodes 23 are connected in parallel. The anode current collectors 65 are then connected to the anode cell terminal 55 in the cell can 56. Electrical connections are also made between the cathode current collectors 24, 84, such that the cathodes 22 are connected in parallel. The cathode current collectors 84 are then connected to the cathode cell terminal 54 in the cell can 56.

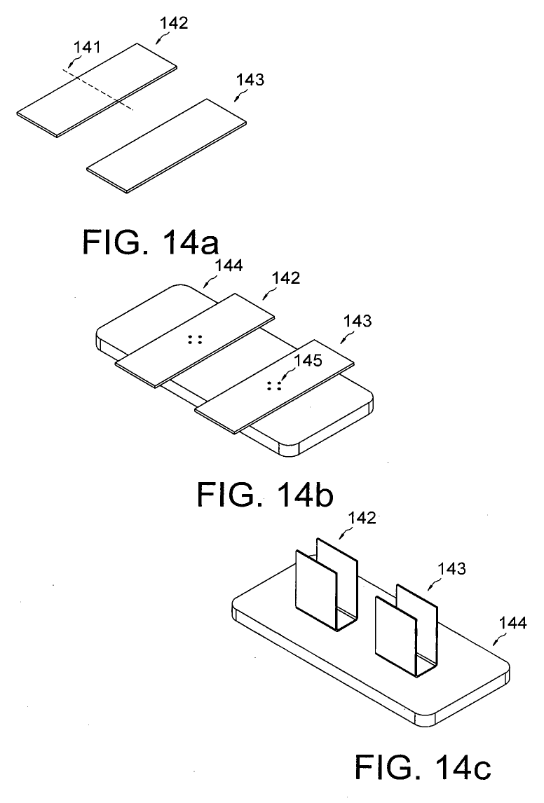

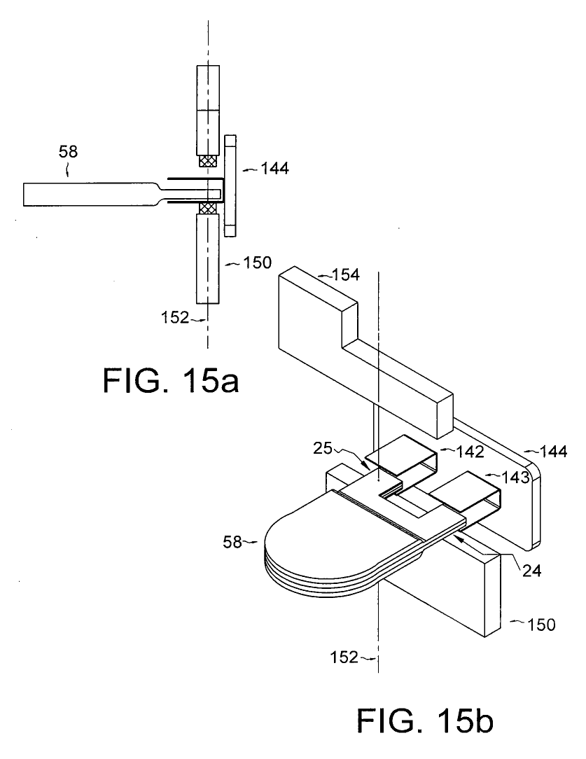

FIGS. 14a-c and FIGS. 15a-b show a method and apparatus for connecting the electrode current collectors 14 to the cell terminals 54, 55 according to one embodiment of the invention. FIG. 14a shows electrode connector tabs 142, 143. Electrode connector tabs are generally elongated tabs comprising a conductive material and a thickness which allows the tabs to be folded along electrode connector tab axis 141. The conductive material according to this embodiment is amenable to laser welding, ultrasonic welding, and the like, so that the electrode connector tabs 142, 143 may be connected, for example by laser welding, ultrasonic welding, fusion welding, resistance welding, and the like, to the current collectors 14 and a tab header 144.

FIG. 14b shows two electrode connector tabs 142, 143 proximate a tab header 144. The tab header 144, according to one embodiment of the invention, comprises a material that is amenable to laser welding, ultrasonic welding, fusion welding, resistance welding, and the like, and that provides an electrical connection between the electrode connector tabs 142, 143 and the cell terminals 54, 55. For example, the tab header 144 may comprise the cell terminals 54, 55, such that the anode electrode connector tab 142 facilitates electrical conduction between the anode current collectors 25 and the anode cell terminal 55; the cathode electrode connector tab 143 similarly facilitates electrical conduction between the cathode current collectors 24 and the cathode cell terminal 54. A laser weld 145 may be used to secure the electrode connector tabs 142, 143 to the tab header 144. After laser welding, the electrode connector tabs 142, 143 are folded along electrode connector tab axis 141 in a manner that allows the folded electrode connector tabs 142, 143 to receive the cathode and anode current collectors 24, 25, as shown in FIG. 14c.

In a further embodiment of the invention (as shown in FIGS. 15a and 15b ), an ultrasonic weld 152 may be used to connect the electrode connector tabs 142, 143 to the cathode and anode current collectors 24, 25. First, the cathode and anode current collectors 24, 25 are positioned within the folded electrode connector tabs 142, 143 as shown in FIG. 15a. Then the assembly is placed on an anvil 150 where the folded electrode connectors 142, 143 are pressed together, forming a connection between the cathode and anode current collectors 24, 25 and the electrode connector tabs 142, 143. Next, the current collectors 24, 25 are secured to the electrode connector tabs 142, 143 and the tab header 144 using, for example, an ultrasonic weld 152.

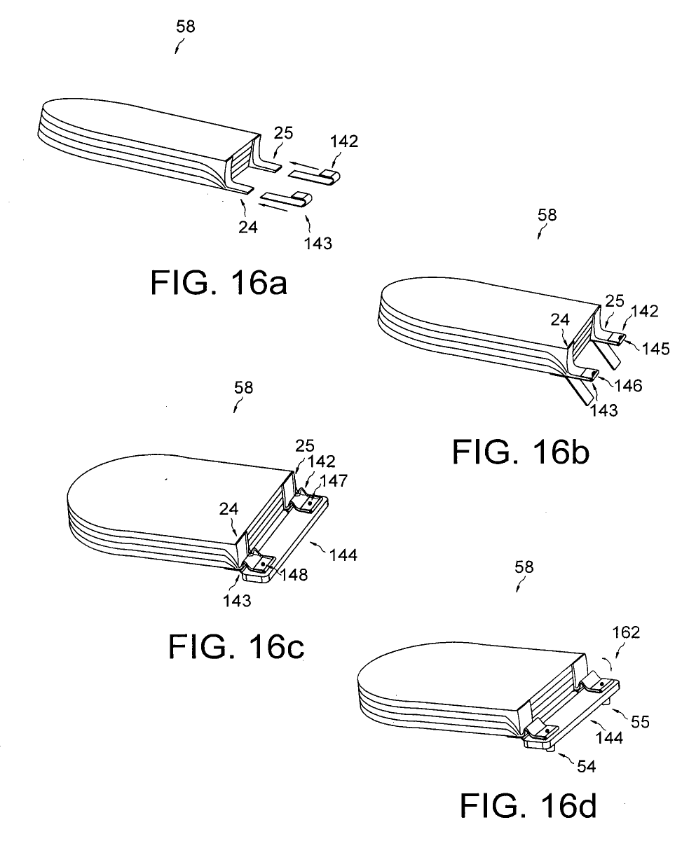

In accordance with an exemplary embodiment of the invention, FIGS. 16a-d show another method for connecting electrode current collectors 24, 25 to cell terminals 54, 55. In this embodiment, electrode connector tabs 142, 143 are folded in order to receive electrode current collectors 24, 25. With reference to FIG. 16a, electrode connector tabs 142, 143 are folded such that the folded portion overlaps the electrode current collectors, and the unfolded portion extends under the stacked plate cell. After the electrode connector tabs are folded, the electrode current collectors are positioned proximate the folded electrode connector tabs. An electrical connection is then formed between the electrode connector tabs and the current collectors. In various embodiments, electrode current collectors 24, 25 are welded to electrode connector tabs 142, 143 in order to form the electrical connection. For example, welds 145, 146, such as laser welds, ultrasonic welds, fusion welds, resistance welds, tungsten inert gas (TIG) welds, and other known means for welding may be used to form the electrical connection. After the electrical connection is formed, the unfolded portion of the electrode connector tabs is folded in order to receive tab header 144 (see FIGS. 16b-c). Then tab header 144 is electrically connected to electrode connector tabs 142, 143, for example, by welds 147, 148, where welds 147, 148 may comprise any known means for welding that results in electrical connections between terminals 54, 55 and current collectors 24, 25, such as laser welds, ultrasonic welds, and the like. Following connection to electrode connector tabs 142, 143, tab header 144 is folded in tab header folding direction 162 such that tab header 144 is located adjacent to stacked plate cell 58, and such that terminals 54, 55 are located appropriately to be placed within a cell can 56.

According to an exemplary embodiment, after the cathode and anode current collectors 24, 25 have been connected, the cell stack 58 is placed in cell can 56 in order, for example, to provide rigidity and support for the cell stack 58 and to enable operation of the stacked plate electrochemical device 50. The cell can 56 is then sealed, for example, to protect the electrodes 22, 23 and the other contents of the cell can 56, and to prolong the life of the stacked plate electrochemical device 50. For example, the cell can 56 may comprise a gasket which provides a weather resistant or weather proof barrier to the electrochemical device. In another embodiment, the cell can 56 may be hermetically sealed, which aids in protecting the stacked plate cell. In a further embodiment, the cell can 56 may be sealed under pressure in order, for example, to protect the stacked plate cell against vibrations and shock. In yet another embodiment, the seal may prevent oxygen from entering the cell can 56 and interfering with the functionality of the cathodes and anodes 22, 23. In various embodiments, the cell can 56 may be sealed by a press fit, an adhesive, a welding instrument, such as laser welding, ultrasonic welding, and the like, and by other fastening means known in the art.

In the various exemplary embodiments disclosed throughout, the terms “cathode” and “anode” have been used to describe the stacked elements in the stacked plate cell. These terms are not intended to limit the scope of the present invention; rather, those skilled in the art will understand that different terminology exists depending on the type of stacked plate cell being created. For example, “cathode” and “anode” may be used when referring to elements of primary batteries, whereas “positive” and “negative” electrodes may be used when referring to secondary batteries. As the present invention contemplates both types of batteries, “cathode” and “anode” are used exclusively to refer to the different types of electrodes.

It should be understood that various principles of the invention have been described in illustrative embodiments. However, many combinations and modifications of the above-described formulation, proportions, elements, materials, and components used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered.

I claim:

1. A method for stacking electrodes to form an electrode package for use in a cell stack and a stacked plate cell battery, comprising the steps of:
a) providing
i) a dual-electrode anode plate, comprising a first anode, a second anode, and an anode current collector;
ii) a dual-electrode cathode plate, comprising a first cathode, a second cathode, and a cathode current collector;
iii) a plurality of separators; and
iv) a cell can;
b) folding the anode dual-electrode plate and the cathode dual-electrode plate together forming an electrode package, wherein the order of the cathodes and the anodes within the electrode package comprises:
i) the first cathode;
ii) the first anode;
iii) the second cathode; and
iv) the second anode;
d) inserting at least one of the plurality of separators between the first cathode and the first anode;
e) inserting at least one of the plurality of separators between the first anode and the second cathode; and
f) inserting at least one of the plurality of separators between the second cathode and the second anode;

2. The method of claim 1, further comprising the steps of
a) providing a plurality of electrode packages;
b) stacking the plurality of electrode packages, such that the electrodes alternate throughout the plurality of electrode packages;
c) placing a finishing separator on the top of the plurality of electrode packages; and
d) placing a singe anode electrode on the top of the finishing separator, forming the cell stack, wherein the cell stack comprises alternating cathodes and anodes throughout the cell stack.

3. The method of claim 2, further comprising the steps of:
a) providing a cathode terminal and an anode terminal;
b) connecting the anode current collectors to the anode terminal; and
c) connecting the cathode current collectors to the cathode terminal, forming the stacked plate cell battery.

4. A method of producing a dual-electrode plate, comprising the steps of:
a) providing a foil and a slurry;
b) forming a first region on said foil with said slurry;
c) forming a second region on said foil with said slurry;
d) curing said first and second regions to form a first electrode and a second electrode;
e) modifying said foil to produce the dual-electrode plate.

5. A method for making a stacked plate electrochemical device, comprising the steps of:
providing:
a first dual electrode plate, comprising a first electrode and a second electrode;
a second dual electrode plate, comprising a third electrode and a fourth electrode; and
a connector tab;
folding said first and second dual electrode plates together, forming a stacked plate cell, such that said electrodes are arranged within said stacked plate cell in an order, said order comprising: said first electrode, said third electrode, said second electrode, and said fourth electrode;
attaching said connector tab to said stacked plate cell;
attaching said connector tab to a tab header; and
inserting said stacked plate cell into a cell can, thereby forming the stacked plate electrochemical device.
